(19) United States
(12) Patent Application Publication
(10) Pub. No.: US 2004/0134968 A1
(43) Pub. Date: Jul. 15, 2004

(54) Positioning and/or assembly aid and corresponding process

(76) Inventor: Reinhold Opper, Buseck (DE)

Correspondence Address: HARNESS, DICKEY & PIERCE, P.L.C., P.O. BOX 828, BLOOMFIELD HILLS, MI, 48303, US

(21) Appl. No.: 10/688,240

(22) Filed: Oct. 17, 2003

Related U.S. Application Data
(63) Continuation of application No. PCT/EP02/04019, filed on Apr. 11, 2002.

(30) Foreign Application Priority Data
Apr. 18, 2001 (DE) DE 101 19 018.2

(51) Int. Cl. B23K 31/12

(52) U.S. Cl. 228/103

(57) ABSTRACT

The present invention relates to a positioning and/or assembly aid (2) for devices (1) for machining at least one component (3, 4) by using at least one connecting element (5) such as a rivet, punch rivet, blind rivet, rivet nut, weld nut, weld stud, clip or the like and to a process for positioning components (3, 4) in a device (1) for machining at least one component (3) while using at least one connecting element such as a rivet, punch rivet, blind rivet, rivet nut, weld nut, weld stud, clip. The invention has means (6) for producing a light or laser beam (7) alignable from a reference position (11) towards a reference point (12). The present invention is suitable for punch rivet, nut welding, stud welding, weld fast, plastifast, blind rivet, and rivet nut, in particular for corresponding manually operable hand devices in prototype construction.

### CROSS-REFERENCE TO RELATED APPLICATIONS

This application is a continuation of International Application No. PCT/EP02/04019, filed Apr. 11, 2002. This application claims the benefit of German Patent Application DE 101 19018.2 filed Apr. 18, 2001. The disclosures of the above applications are incorporated herein by reference.

### FIELD OF THE INVENTION

The present invention relates to a positioning and/or assembly aid for devices for machining at least one component by using at least one connecting element such as a rivet, punch rivet, blind rivet, rivet nut, weld nut, weld stud, clip or the like and to a process for positioning components in a device for machining at least one component while using at least one connecting element such as a rivet, punch rivet, blind rivet, weld nut, weld stud, clip or the like.

### BACKGROUND OF THE INVENTION

Known devices for processing at least one connecting element such as a rivet, punch rivet, blind rivet, rivet nut, weld nut, weld stud, clip or the like are, for example, punch rivet systems, nut welding systems, stud welding systems, weld fast systems, plastifast systems, blind rivet systems, rivet nut systems or the like. They are used manually, on robots and/or stationarily, for example in mass production of motor vehicles, wherein the connecting element is to be centred, preferably automatically, at a certain position respectively to a component, generally a metal sheet, waiting to be machined.

Accordingly, in prototype construction, for example of a new motor vehicle, appropriate hand devices for processing a connecting element such as a rivet, punch rivet, blind rivet, rivet nut, weld nut, weld stud, clip or the like are generally used. In manual and/or stationary hand units of this type, in particular positioning of the connecting element itself is also to be carried out manually and this is generally only possible by using relatively expensive auxiliary devices such as templates, combs, masks or the like. Therefore, the position of the connecting element is often also marked by scoring on the component. However, it is not easy to accurately coincide with this mark, depending on the size and geometry of the component, as in some cases no auxiliary devices such as templates etc. can be used.

### SUMMARY OF THE INVENTION

The object of the present invention is to provide a positioning and/or assembly aid which improves on the state of the art and a corresponding process. In particular, the expensive auxiliary devices known in the state of the art are to be omitted.

This object is achieved according to the invention by a positioning and/or assembly aid according to the claims.

The positioning and/or assembly aid according to the invention for devices for machining at least one component while using at least one connecting element such as a rivet, punch rivet, blind rivet, rivet nut, weld nut, weld stud, clip or the like is characterised in that means for producing a light or laser beam are provided which can be aligned from a reference position towards a reference point. Utilization of a light or laser beam advantageously avoids the production and use of expensive auxiliary devices such as templates, combs, masks or the like and accordingly helps to reduce costs in prototype construction.

The reference position is preferably outside of the device, in particular clearly outside a machining space of the device bridged by a machining vertical line.

In contrast, the reference point is preferably located on the machining vertical line which preferably extends through the centre of a support of the device.

According to a further embodiment of the invention the reference point is arranged at a distance from the support, in particular arranged at an adjustable distance, preferably increased by the material thickness of the at least one component to be machined. In manually operated hand units in prototype construction the reference point is preferably adjusted by manual means. Projecting of the reference point on the support corresponds, for example, to a starting position or a zero point. By means, for example of a spindle, the reference point can now be varied in such a way that it is arranged at a distance from the support. The distance from the support preferably corresponds in this case to the component thickness, for example, the thickness of one or more metal sheets to be processed. Automatic adjusting means are, however, also possible. They are preferably used in defined mass production and advantageously allow automatic processing not only of a certain component but also of various components such as metal sheets with different thicknesses, advantageously also in succession on an automatic production line.

According to the invention the light or laser beam is preferably obliquely directed from outside of the device onto the reference point. This is advantageous both in manual prototype construction and in automated mass production. Therefore, the angular position of the means producing the light beam ensure in an advantageous manner that the reference point is correctly hit only from a quite specific height. This height preferably coincides with a basic or starting position of the device or else a position characterising the machining and which the device adopts either once or cyclically and advantageously facilitates optionally automated machining even of different components in succession.

According to the invention the light or laser beam can preferably be variably projected and/or focussed, in particular as a point or as a diameter of the connecting element, onto the component.

The light or laser beam preferably co-operates alternatively or cumulatively with a template in such a way that device-related interference contours, such as the diameter of a mouthpiece of the device or the diameter of the support and also other geometric shapes such as square, triangle, ellipse or the like, can be projected and/or focussed onto the component. The ability to simulate interference contours such as mouthpieces, holding devices, supports or the like in particular advantageously avoids carrying out operating process steps outside of a defined operating space and therefore in particular protects the component from accidental damage or even destruction.

The process according to the invention for positioning components in a device for machining at least one component while using at least one connecting element such as rivet, punch rivet, blind rivet, rivet nut, weld nut, weld stud, clip or the like comprises a positioning and/or assembly aid according to the invention and is characterised in that a mark is initially made on the top of at least one uppermost component and the component mark and the light or laser beam are then positioned congruently one above the other. In hand units in prototype construction positioning is preferably carried out manually but can also be automated when the invention is used in mass production, for example, by using an optical positioning system.

According to the invention the mark preferably has the shape of a crosshair, a point or another shape, in particular the shape of the connecting elements to be processed, or, a generally device-related, interference contour.

The invention advantageously allows positioning of components in a device for machining at least one component by using at least one connecting element such as a rivet, punch rivet, blind rivet, rivet nut, weld nut, weld stud, clip or the like, and also positioning of a device of this type itself, in particular a manually operable hand unit, on a component with simple means. It can also advantageously be retrofitted simply and relatively inexpensively in the known existing devices.

Further advantages and details of the invention will be described with the aid of an embodiment of a so-called SPR unit i.e. a setting machine, for example for weld studs or rivets, shown in the drawings but to which the invention is not restricted.

### BRIEF DESCRIPTION OF THE DRAWINGS

In the drawings:

FIG. 1 is an elevational view of a positioning and/or assembly aid according to the invention for devices for machining at least one component while using at least one connecting element such as a rivet, punch rivet, blind rivet, rivet nut, weld nut, weld stud, clip or the like; and

FIG. 2 is an elevational view of the positioning and/or assembly aid according to FIG. 1 in an enlarged detail.

### DETAILED DESCRIPTION OF THE PREFERRED EMBODIMENTS

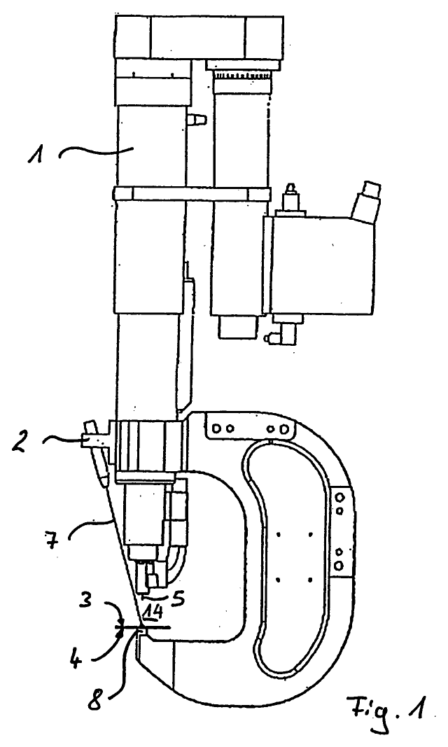

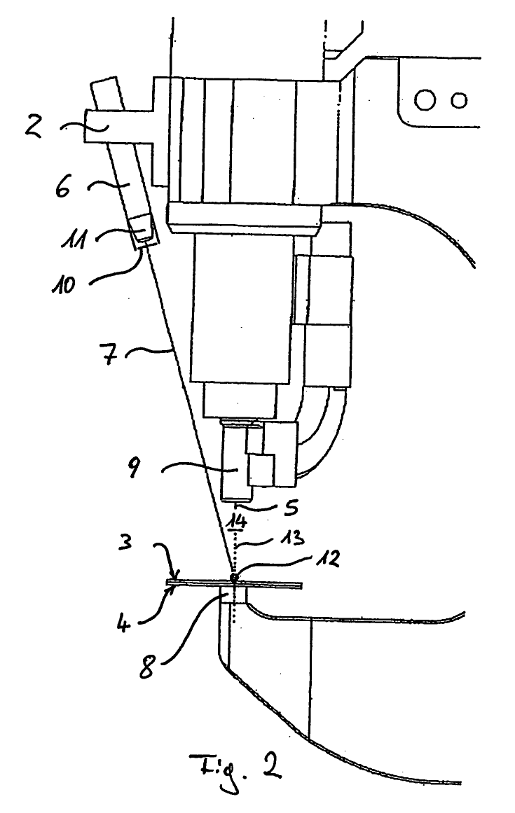

FIGS. 1 and 2 show a positioning and/or assembly aid 2 according to the invention for devices 1 for machining at least one component 3, 4 while using at least one connecting element 5 such as a rivet, punch rivet, blind rivet, rivet nut, weld nut, weld stud, clip or the like. A so-called memory test routine unit is shown as device 1, on which means 6 for producing a light or laser beam 7 are arranged. The light or laser beam 7 can be aligned from a reference position 11 towards a reference point 12, the latter defining the machining point of connection element 5 and component 3, 4 in the device 1. Like the positioning and/or assembly aid 2, the reference position 11 is also located outside the device 1, in particular clearly outside of a machining vertical line 13. This preferably extends through the centre of a support 8 which can be a tool, for example a lower die 8 as in the present case, or another suitable counterforce structure. The machining vertical line 13 also defines the centre line of a machining clearance zone 14 located between the lower die 8 and a mouthpiece 9 or the device 1. The reference or machining point 12 is also located on the machining vertical line 13, albeit at a distance from the lower die 8, in particular increased by the material thickness of the at least one component 3, 4 to be machined. The above-mentioned distance can advantageously be adjusted in a defined manner, in particular appropriately increased, if a plurality of components are to be machined simultaneously, as in the case shown, if an upper 3 and a lower 4 component are to be machined at the same time. The light or laser beam 7 is also directed obliquely from outside of the device 1 onto the reference or machining point 12, so this advantageously strikes accurately only at a quite specific height.

The light or laser beam 7 can preferably be variably projected and/or focussed on to the reference or machining point 12, in particular as a point or as a diameter of the connecting element 5.

The light or laser beam 7 can alternatively or cumulatively also co-operate with a template 10 shown in FIG. 2 in such a way that interference shapes such as the diameter of a mouthpiece 9 of the device 1 or the diameter of the lower die 8 and other geometric shapes such as a square, triangle, ellipse or the like can also be projected and/or focussed. In addition, FIG. 2 shows the positioning and/or assembly aid according to FIG. 1 in an enlarged detail.

The present invention is in particular suitable for devices such as punch rivet systems, nut welding systems, stud welding systems, weld fast systems, plastifast systems, blind rivet systems, rivet nut systems or the like, in particular for corresponding manually operable hand devices in prototype construction, preferably the motor vehicle industry.

What is claimed is:

1. A processing device connecting element positioning aid, comprising:
a processing device operable to process at least one component;
a light emitting element operably producing a light beam, the light emitting element connectable to the processing device;
a reference position of the light emitting element from which the light emitting element is alignable to operably direct the light beam towards a reference point; and
at least one connecting element connectable to the at least one component at the reference point.

2. The positioning aid of claim 1, wherein the light beam comprises a laser beam.

3. The positioning aid of claim 1, wherein the connecting element comprises at least one of a rivet, a punch rivet, a blind rivet, a rivet nut, a weld nut, a weld stud, and a clip.

4. The positioning aid of claim 1, comprising an envelope of the processing device, wherein the reference position is locatable outside of the envelope.

5. The positioning aid of claim 4, comprising a machining space of the processing device, wherein the reference position is locatable outside of the machining space.

6. The positioning aid of claim 5, wherein the reference position is bridged by a machining vertical line.

7. The positioning aid of claim 6, comprising:
a device support having a center;
wherein the reference point is locatable on the machining vertical line and the machining vertical line is extendable through the center of the device support.

8. The positioning aid of claim 7, wherein the reference point is arranged at a distance from the device support.

9. The positioning aid of claim 8, wherein the distance comprises an adjustable distance increasable by a total material thickness of the at least one component.

10. The positioning aid of claim 1, wherein the light beam is directable onto the reference point from outside of the processing device at an oblique orientation.

11. The positioning aid of claim 1, comprising a variably projectable light beam.

12. The positioning aid of claim 11, wherein the variably projectable light beam is operably projected onto the component as one of a point and a diameter of the connecting element.

13. The positioning aid of claim 1, comprising a variably focusable light beam.

14. The positioning aid of claim 13, wherein the variably focusable light beam is operably focused onto the component as one of a point and a diameter of the connecting element.

15. The positioning aid of claim 11, comprising a template, wherein the variably projectable light beam is in operable cooperation with the template such that a device-related interference contour is projectable onto the component.

16. The positioning aid of claim 15, wherein the device-related interference contour includes one of a diameter of a mouthpiece, a device support diameter, and one of a plurality of geometric shapes including a square, a triangle and an ellipse.

17. The positioning aid of claim 13, comprising a template wherein the variably focusable light beam is in operable cooperation with the template such that a device-related interference contour is focusable onto the component.

18. The positioning aid of claim 17, wherein the device-related interference contour includes one of a diameter of a mouthpiece, a device support diameter, and one of a plurality of geometric shapes including a square, a triangle and an ellipse.

19. A method for positioning at least one component in a device for processing the component, the method comprising:
producing a light beam with a light beam emitter;
positioning the light beam emitter at a reference position to operably direct the light beam towards a reference point;
placing a mark on an uppermost one of a component to be processed;
congruently positioning one of the mark and the light beam above the other; and
processing the component.

20. The method of claim 19, comprising shaping the mark as one of a crosshair, a point and a device-related interference contour.

21. The method of claim 19, comprising aligning a connecting element with the component at the reference point.

22. The method of claim 21, comprising shaping the mark to match a shape of the connecting element.

23. A positioning aid assembly for a processing device, comprising:
a light beam emitter operably projecting a light beam as one of a variably projectable light beam and a variably focusable light beam; and
a reference position for operably positioning the light beam emitter from which the light beam is operably directable towards a reference point;
wherein the reference position is locatable outside of an envelope of a processing device such that the light beam is operably directable onto the reference point from an oblique orientation.

24. The assembly of claim 23, wherein the light beam comprises a laser beam.

25. The assembly of claim 23, wherein the reference point is locatable within the processing device envelope.

26. The assembly of claim 23, wherein the variably projectable light beam is operably projectable as one of a point, a diameter of a connecting element and a device-related interference contour.

27. The assembly of claim 23, wherein the variably focusable light beam is operably focusable as one of a point, a diameter of a connecting element and a device-related interference contour.

28. A method for positioning at least one component in a device for processing the component, the method comprising:
producing a light beam with a light beam emitter;
positioning the light beam emitter at a reference position to operably direct the light beam towards a reference point;
mounting at least one component for processing;
aligning a connecting element taken from the group including a rivet, a punch rivet, a blind rivet, a rivet nut, a weld nut, a weld stud and a clip with the reference point;
placing a mark on an uppermost one of the components;
congruently positioning one of the mark and the light beam above the other; and
processing both the connecting element and the at least one component.

29. The method of claim 28, comprising joining the connecting element together with the at least one component.

30. The method of claim 28, comprising adjusting a height of the light beam to correspond to a total thickness of the at least one component.
